(19) United States
(12) Patent Application Publication
(10) Pub. No.: US 2005/0173908 A1
(43) Pub. Date: Aug. 11, 2005

(54) Airbag system

(75) Inventors: Akifumi Takedomi, Yokaichi-shi (JP); Atsushi Noguchi, Moriyama-shi (JP)

Correspondence Address: FOLEY AND LARDNER;SUITE 500, 3000 K STREET NW, WASHINGTON, DC, 20007, US

(73) Assignee: TAKATA CORPORATION

(21) Appl. No.: 11/049,937

(22) Filed: Feb. 4, 2005

(30) Foreign Application Priority Data
Feb. 9, 2004 (JP) 2004-032341

(51) Int. Cl. B60R 21/16; B60R 21/22

(52) U.S. Cl. 280/743.2; 280/730.2

(57) ABSTRACT

An airbag system conductive to perfect protection of occupants in the event of a vehicle accident. An airbag system to be mounted to the upper part of the sidewall of a vehicle is constructed such that a tension rope which passes through a first airbag and a second airbag is fixed (locked) by a fixing device and the movements of the first airbag and the second airbag which are deploying in occupant protection regions toward the exterior of the vehicle cabin and the upper part of the vehicle are restricted via the tension rope.

### BACKGROUND

The present invention relates to an airbag system mounted in a vehicle such as a car, and more specifically, it relates to a technique for constructing an airbag system for preventing occupants from striking against the sidewall of a vehicle in the event of an accident such as a side collision or turnover of the vehicle.

Various techniques for constructing an airbag system have been proposed to prevent occupants from striking against the sidewall of a vehicle such as a side window or a door in the event of an accident such as a side collision or turnover of the vehicle. For example, it is known in the art to provide the structure of an airbag system including an airbag housed along the side-roof rail of a vehicle, such as the airbag system disclosed in Japanese Unexamined Patent Application Publication No. 2001-328504 (hereby incorporated by reference herein in it entirety). The conventional airbag system describes a technique for inflating and deploying an airbag reliably in a vehicle including two-rows of seats. However, it requires a further technical search to achieve a high-level technique for inflating a large airbag into an occupant protection region between a vehicle sidewall and occupants in a large vehicle in which multiple rows of seats can be disposed.

The present invention has been made in consideration of the above respect and, it is an object of the invention to provide a technique for constructing an airbag system conducive to complete protection of occupants in the event of a vehicle accident.

### SUMMARY

One embodiment of the invention relates to an airbag system to be mounted in a vehicle capable of having a plurality of rows of seats. The airbag system comprises a plurality of airbags mounted to the upper part of the sidewall of the vehicle and, in the event of an accident, configured to deploy downward separately toward occupant protection regions between occupants sitting in the seats and the sidewall of the vehicle; gas supply device capable of supplying inflating gas into the plurality of airbags; and a single restricting mechanism configured to restrict the movement of the plurality of airbags deploying into the occupant protection regions toward the exterior of the vehicle cabin.

According to another embodiment, an airbag system to be mounted in a vehicle capable of having three rows of seats is provided. The airbag system comprises first and second airbags mounted to the upper part of the sidewall of the vehicle and, in the event of an accident, configured to deploy downward separately toward occupant protection regions between occupants sitting in the seats and the sidewall of the vehicle; a gas supply device configured to supply inflating gas into the first and second airbags; and wherein a single restricting mechanism extends longitudinally along the length of the vehicle in the lower part of the first and second airbags deploying into the occupant protection regions, and includes a rope member in engagement with the lower part of the first and second airbags and a fixing device for fixing the rope member, and wherein the single restricting mechanism is configured to restrict the movement of the first and second airbags deploying into the occupant protection regions toward the exterior of the vehicle cabin.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a schematic diagram showing a state in which an airbag system according to an embodiment is mounted in a vehicle body.

FIG. 2 is a cross sectional view of a B-pillar 14, taken along line A-A of FIG. 1.

FIG. 3 is a diagram showing the structure of the airbag system 100 in FIG. 2, showing a state in which an airbag 120 is deployed.

FIG. 4 is a diagram of the airbag 120 in FIG. 3 in a fully deployed state, as viewed from the front of a vehicle.

FIG. 5 is a diagram of the airbag 120 in FIG. 3 in a fully deployed state, as viewed from the side of a vehicle.

### DETAILED DESCRIPTION

In one embodiment, an airbag system is mounted in the vehicle capable of having a plurality of rows of seats, or two rows or more of seats, and includes at least a plurality of airbags, gas supply device, and single restricting mechanism.

The airbags are mounted to the upper part of the sidewall of the vehicle and, in the event of an accident, deploy downward toward occupant protection regions between occupants sitting in the seats and the sidewall of the vehicle. The airbags have the function of protecting the heads and shoulders of the occupants particularly from the input of a side impact.

The “sidewall of a vehicle” includes the components of the vehicle located on the side (the right and left) of occupants and, typically, includes side windows and doors. The airbags are mounted to the boundary between the side-roof panel and the ceiling panel at the upper part of the sidewall of the vehicle.

According to an embodiment of the invention, the multiple airbags deploy separately in the occupant protection regions. “A plurality of airbags deploying in the occupant protection regions” denotes multiple airbags that each deploy in the respective separated occupant protection regions. For example, an embodiment can include, in a vehicle capable of having three-rows of seats, a first airbag which deploys in an occupant protection region corresponding to a first-row seat and a second airbag which is disposed separately from the first airbag and deploys from an occupant protection region corresponding to a second-row seat across an occupant protection region corresponding to a third-row seat.

According to an embodiment, inflating gas is supplied to the multiple airbags with a gas supply device such as an inflator having the function of generating gas. The gas supply device may be provided individually for each airbag and thus can supply gas to each airbag or, alternatively, may be provided for the multiple airbags in common and thus can supply gas to the airbags in parallel.

The single restricting mechanism, according to an embodiment, is a single mechanism that restricts the movement of the plurality of airbags deploying into the occupant protection regions toward the exterior of the vehicle cabin. In other words, the invention uses a restricting mechanism in which the function of restricting the movements of the fully deployed airbags toward at least the exterior of the vehicle cabin is used for the multiple airbags. In general, when occupants strike against the inflated airbags in the event of an accident, such as a side collision or turnover of the vehicle, a load toward the exterior of the vehicle cabin is applied to the airbags and so the airbags are urged toward the exterior of the vehicle cabin. Accordingly, the embodiments can have a structure in which the movements of the deploying airbags toward the exterior of the vehicle cabin are restricted by the restricting mechanism.

The “restriction” in the invention denotes restriction of the movements of deploying airbags toward at least the exterior of the vehicle cabin, and includes not only complete restriction of the movements of deploying airbags toward at least the exterior of the vehicle cabin but also restriction in which the movements occur slightly due to the elasticity of the airbags.

This airbag system is suitable for large vehicles in which multiple rows of seats can be disposed. Specifically, since the airbag system includes multiple airbags, the deviation of time required to inflate the airbags can be decreased to allow a well-balanced inflating action even when the occupant protection regions extend to increase the inflation volume of the entire airbag as vehicles increase in size.

According to an embodiment, the movements of the fully deployed airbags toward at least the exterior of the vehicle cabin are restricted by the restricting mechanism, thus increasing the capability of holding the occupants in a cabin in the event of an accident such as a side collision or turnover of the vehicle. Particularly, since embodiments use a restricting mechanism which has the function of restricting the movement of the airbag for multiple airbags, a rational low-cost airbag system can be constructed as compared with that having a restricting mechanism for each airbag.

The single restricting mechanism according to an embodiment can have a structure in which multiple airbags are in engagement with a single member retained to a vehicle, or a structure in which multiple airbags are retained indirectly to the vehicle with a single member or, alternatively, a structure in which one of joined airbags is retained directly to the vehicle.

The airbag system according to another embodiment is constructed such that the single restricting mechanism includes a rope member and a fixing device.

The rope member according to an embodiment extends longitudinally along the length of the vehicle in the lower part of the airbags deploying into the occupant protection regions and is in engagement with the lower part of the plurality of airbags. The “rope member” here includes various rod-like (cylindrical) or planar ropes, straps, and strings. The engagement of the multiple airbags and the rope member may have a structure in which the rope member is passed through a through hole which passes through the interior and the exterior of the airbags, a structure in which the rope member is passed trough a through hole provided at the lower part of the outer surface of the airbags, or a structure in which the rope member is sewn onto the lower part of the outer surface of each airbag.

The fixing device according to an embodiment has the function of fixing (locking) the rope member. When the rope member is fixed (locked) with the fixing device, the movements of multiple airbags that are in engagement with the rope member toward at least the exterior of the vehicle cabin are restricted. Since airbags which have deployed downward from above the vehicle sidewall have generally more flexibility at the lower part than at the upper part, restricting the action of the lower part of the airbags is effective in surely restricting the action of the entire airbag. Accordingly, the rope member 19 is in engagement with the lower part of the multiple airbags.

It is preferable that the rope member be constructed such that it is in engagement with the deploying multiple airbag so as to restrict the movements of the airbags toward the exterior of the vehicle cabin and the upper part of the vehicle. This ensures that the multiple airbags deploying in the occupant protection regions extend in sheet form on the side of occupants, thus contributing to perfect protection of occupant particularly at a side impact.

The airbag system according to the embodiment ensures restriction of the movements of deploying multiple airbags toward at least the exterior of the vehicle cabin with the simple restricting mechanism including a rope member and a fixing device for fixing (locking) the rope member, thus achieving complete protection of occupants.

The airbag system according to yet another embodiment is constructed such that the rope member is disposed in a state in which the plurality of airbags are passed along the length of the vehicle, with the airbags housed in the upper part of the sidewall of the vehicle. Specifically, the rope member is passed through a through hole that passes through the interior and the exterior of the airbags, so that the rope member is brought into engagement with the multiple airbags. This restricts the movements of the deploying airbags toward the exterior of the vehicle cabin and the upper part of the vehicle via the rope member.

The airbag system of this embodiment has a rope member which passes through the multiple airbags, thus simplifying the engagement of the rope member and the multiple airbags. Since the movements of the deploying multiple airbags toward the exterior of the vehicle cabin and the upper part of the vehicle can be restricted by the rope member at a time, it is rational.

The airbag system according to another embodiment is mounted in the vehicle in which three-rows of seats can be disposed and includes at least first and second airbags, gas supply device, and a single restricting mechanism.

The first and second airbags according to an embodiment are mounted to the upper part of the sidewall of the vehicle and, in the event of an accident, deploy downward toward occupant protection regions between occupants sitting in the seats and the sidewall of the vehicle. The first and second airbags deploy separately in the occupant protection regions. For example, the first airbag deploys in an occupant protection region corresponding to the first-row seat and a second airbag deploys in occupant protection regions corresponding to the second-row seat and the third-row seat. Inflating gas is supplied to the first and second airbags with gas supply device such as an inflator having the function of generating gas.

The single restricting mechanism according to an embodiment has the function of restricting the movements of the first and second airbags deploying into the occupant protection regions toward the exterior of the vehicle cabin. In other words, the invention uses a restricting mechanism in which the function of restricting the movements of the fully deployed airbags toward at least the exterior of the vehicle cabin is used for both of the first and second airbags. In general, when occupants strike against the inflated airbags in the event of an accident such as a side collision or turnover of the vehicle, a load toward the exterior of the vehicle cabin is applied to the airbags and so the airbags are urged toward the exterior of the vehicle cabin. Accordingly, the airbag system can have a structure in which the movements of the deploying first and second airbags toward the exterior of the vehicle cabin are restricted by the restricting mechanism.

The single restricting mechanism according to an embodiment includes a rope member and a fixing device. The rope member extends longitudinally along the length of the vehicle in the lower part of the first and second airbags deploying into the occupant protection regions and is in engagement with the lower part of the first and second airbags. The fixing device has the function of fixing (locking) the rope member. When the rope member is fixed (locked) with the fixing device, the movements of the first and second airbags that are in engagement with the rope member toward at least the exterior of the vehicle cabin are restricted. It is preferable that the rope member be constructed such that it is in engagement with the deploying first and second airbags so as to restrict the movements toward the exterior of the vehicle cabin and the upper part of the vehicle. This ensures that the first and second airbags deploying in the occupant protection regions extend in sheet form on the side of occupants, thus contributing to perfect protection of occupants particularly in the event of a side impact.

Since this airbag system as set forth in the embodiment includes the first and second airbags, the deviation of time required to inflate the airbags can be decreased to allow a well-balanced inflating action even when the occupant protection regions extend to increase the inflation volume of the entire airbags as vehicles increase in size.

In one embodiment, the movements of the fully deployed airbags toward at least the exterior of the vehicle cabin are restricted by the restricting mechanism, thus increasing the capability of holding the occupants in a cabin in the event of an accident such as a side collision or turnover of the vehicle. Particularly, since the embodiment is constructed such that the function of restricting the movement of the airbag is used for both of the first and second airbags, a rational low-cost airbag system can be constructed as compared with that having a restricting mechanism for each airbag. The embodiment can ensure restriction of the movements of the deploying first and second airbags toward at least the exterior of the vehicle cabin with the simple mechanism including a rope member and a fixing device for fixing (locking) the rope member, thus achieving protection of occupants.

The airbag system as set forth in yet another embodiment is constructed such that the rope member as is disposed in a state in which the first and second airbags are passed along the length of the vehicle, with the airbags housed in the upper part of the sidewall of the vehicle. Specifically, according to the embodiment, the rope member is passed through a through hole that passes through the interior and the exterior of the airbags, so that the rope member is brought into engagement with the first and second airbags. This restricts the movements of the deploying first and second airbags toward the exterior of the vehicle cabin and the upper part of the vehicle via the rope member.

In this embodiment, the airbag system has a rope member which passes through the first and second airbags, thus simplifying the engagement of the rope member and the first and second airbags. Since the movements of the deploying first and second airbags toward the exterior of the vehicle cabin and the upper part of the vehicle can be restricted by the rope member at a time, it is rational.

As has been described, the invention includes multiple airbags, and the movements of the airbags which deploy separately in the occupant protection regions toward the exterior of the vehicle cabin and the upper part of the vehicle are restricted with a single restricting mechanism. Thus, an airbag system conductive to perfect protection of occupants in the event of a vehicle accident can be mounted in large vehicles in which three- or multiple-rows of seats can be disposed.

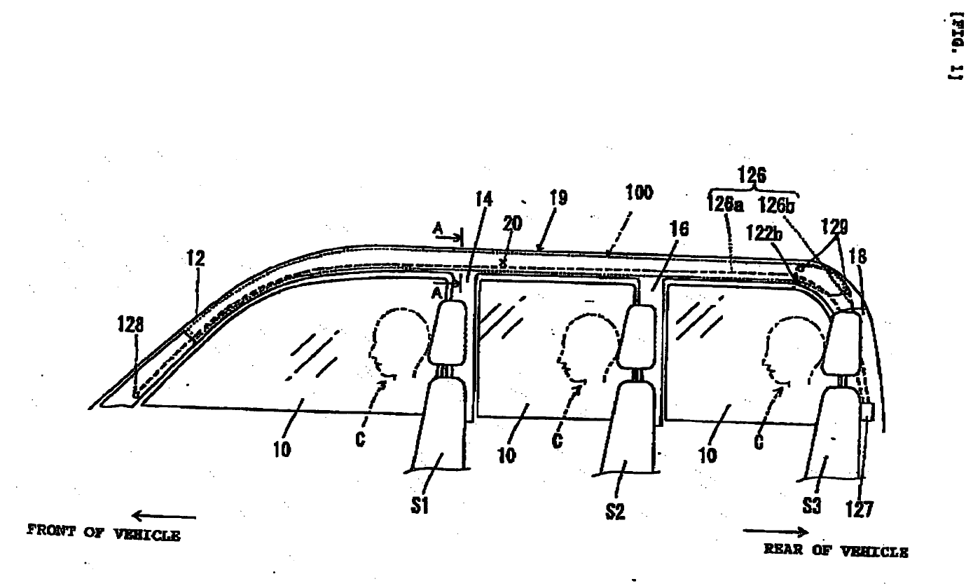

An embodiment of the present invention will be described in detail with reference to the drawings. The structure and operation of an airbag system 100 according to an embodiment of the “airbag system” of the invention will be described with reference to FIGS. 1 to 5. FIGS. 1 to 5 show the airbag system 100 mounted to the right of a car body to protect occupants seated on the right of a vehicle by way of example.

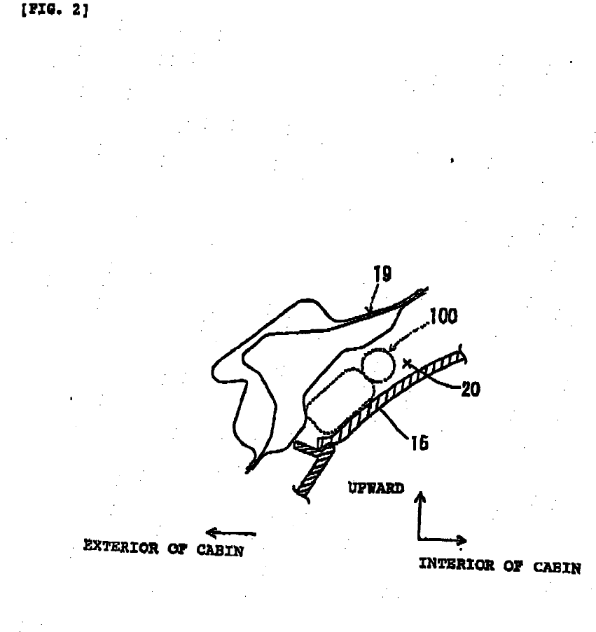

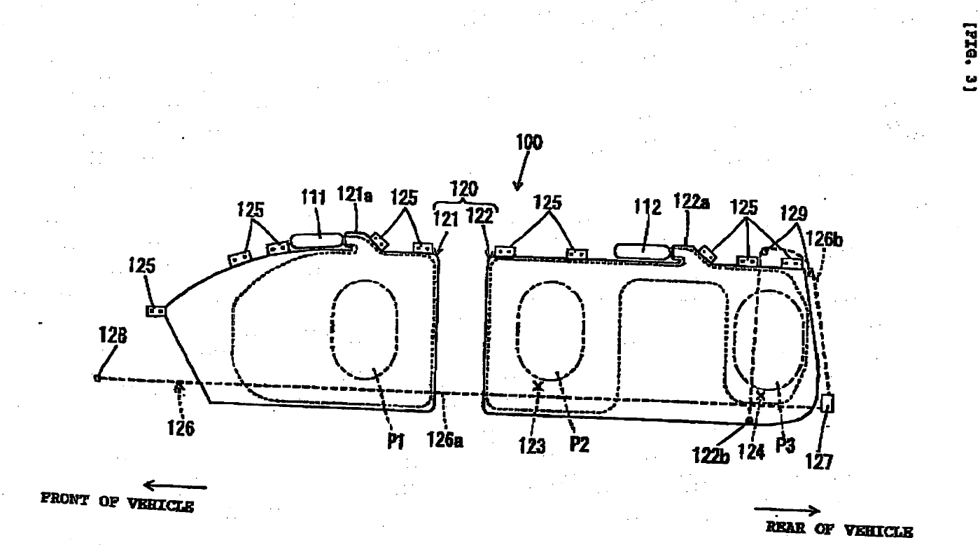

FIG. 1 is a schematic diagram showing a state in which the airbag system 100 according to the embodiment is mounted in a vehicle body. FIG. 2 is a cross sectional view of a B-pillar 14, taken along line A-A of FIG. 1. The airbag system 100 in FIG. 2 is in a state before being activated (in the initial state). FIG. 3 is a diagram showing the structure of the airbag system 100 in FIG. 2, showing a state in which an airbag 120 is deployed. In FIGS. 1 and 3, the left indicates the front of the vehicle, and the right indicates the rear of the vehicle. FIG. 2 shows the right sidewall of the vehicle, in which the right side indicates the interior of the cabin and the left side indicates the exterior of the cabin.

As shown in FIG. 1, the car (vehicle) of this embodiment including the airbag system 100 has a structure in which three rows of seats can be disposed. A first-row seat (first seat) S1, a second-row seat (second seat) S2, and a third-row seat (third seat) S3 are disposed in order from the front of the interior. One or more occupants C can be seated in each row. Such three-row seats may be disposed at all times or may be disposed by changing the seat arrangement as the need arises.

As shown in FIGS. 1 and 2, the airbag system 100 is disposed in a space 20 defined by a ceiling panel 15 and a right side-roof rail (body panel) 19 above a side window 10 and extends along the extending direction of the right side-roof rail 19, from an A-pillar 12 via a B-pillar (a front middle pillar) 14 and a C-pillar (a rear middle pillar) 16 to a D-pillar 18. The airbag system 100, which includes later-described airbag 120 and inflators 111 and 112, is mounted to the upper part of the sidewall of a vehicle.

Referring FIG. 1, the side-roof rail 19 on the right of the body includes a tension rope 126 along the extending direction of the airbag system 100.

The tension rope 126 is a rod-like long rope and includes a first extending part 126a which extends between a fixing portion 128 of the A-pillar 12 and a fixing device (locking device) 127 disposed to the D-pillar 18 and a second extending part 126b which passes through two guides 129 of the D-pillar 18 and extends between a mounting portion 122b of the airbag 120, which will be described later, and the fixing device 127. The first extending part 126a of the tension rope 126 is passed through a through hole (not shown) formed at the lower part of the airbag 120 (at the lower part of a first airbag 121 and a second airbag 122, to be described later). In other words, the tension rope 126 is disposed in a state in which the first airbag 121 and the second airbag 122 are passed along the length of the vehicle, with the airbag 120 housed in the upper part of the vehicle sidewall. The tension rope 126 corresponds to a “rope member.” A planar strap or sting may be used in place of the tension rope 126 of this embodiment.

The fixing device 127 is fixed to the D-pillar 18 and has the function of fixing (lock) the tension rope 126 when the airbag 120 is deployed. The fixing device 127 corresponds to a “fixing device.”

The tension rope 126 and the fixing device 127 have the function of restricting the movement of the fully deployed airbag 120 toward the exterior of the vehicle cabin and the upper part of the vehicle (at least the exterior of the cabin) across the first airbag 121 and the second airbag 122 and serves as “single restricting mechanism,” which will be specifically described later.

The airbag system 100 has the function of protecting occupants quickly and reliably in the event of a vehicle accident such as a side collision or turnover of a vehicle and, more particularly, the function of protecting the heads and shoulders of the occupants from the input of side impact.

The airbag system 100 includes, as its principle components, an airbag housed in a specified folded state (like an accordion or a roll) and an inflator (gas generator) capable of generating inflating gas into the interior of the airbag.

As shown FIG. 3, according to the embodiment, the airbag 120 includes the first airbag 121 disposed in the front of the vehicle and the second airbag 122 disposed in the rear of the vehicle. The first airbag 121 and the second airbag 122 are fixed to the right side-roof rail 19 via multiple brackets 125. The first airbag 121 and the second airbag 122 correspond to “a plurality of airbags” of the invention.

Inflating gas generated from the first inflator 111 is supplied to the first airbag 121 through an inlet 121a. To the second airbag 122, inflating gas generated from the second inflator 112 is supplied through an inlet 122a. The first inflator 111 and the second inflator 112 correspond to the “gas supply device” of the invention.

The first airbag 121 is disposed in a position corresponding to an occupant protection region P1 for an occupant C seated in a first-row seat (first-row seat S1 in FIG. 1) when deployed. The second airbag 122 includes a first inflating part 123 and a second inflating part 124. The first inflating part 123 is disposed in a position that corresponds to an occupant protection region P2 for an occupant C seated in a second-row seat (second-row seat S2 in FIG. 1) when deployed. The second inflating part 124 is disposed in a position that corresponds to an occupant protection region P3 for an occupant C seated in a third-row seat (third-row seat S3 in FIG. 1) when deployed. The occupant protection regions P1, P2, and P3 are formed between the occupants C and the vehicle sidewall and specified as protection regions where at least the heads of the occupants C who set in the respective seats can be protected, which correspond to “occupant protection regions.”

As shown in FIG. 3, when the first airbag 121 and the second airbag 122 have been fully deployed, the tension rope 126 extends along the length of the vehicle, with the first extending part 126a passed through the lower part of the first airbag 121 and the second airbag 122, while the second extending part 126b extends vertically (vertically in FIG. 3) between the mounting portion 122b and the fixing device 127 via the guides 129. At that time, the first extending part 126a and the second extending part 126b of the tension rope 126 are given a specified tension through the fixing device 127. The tension rope 126, which is in engagement with the first airbag 121 and the second airbag 122, has the function of forming a so-called “tension line” along the length of the vehicle, across the first airbag 121 and the second airbag 122.

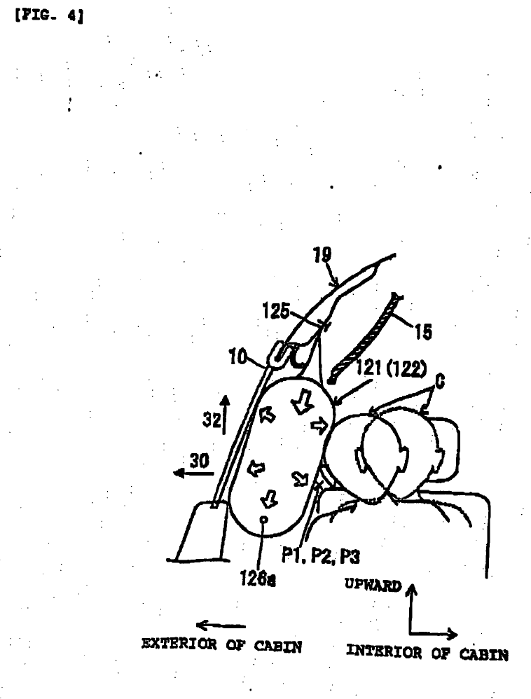

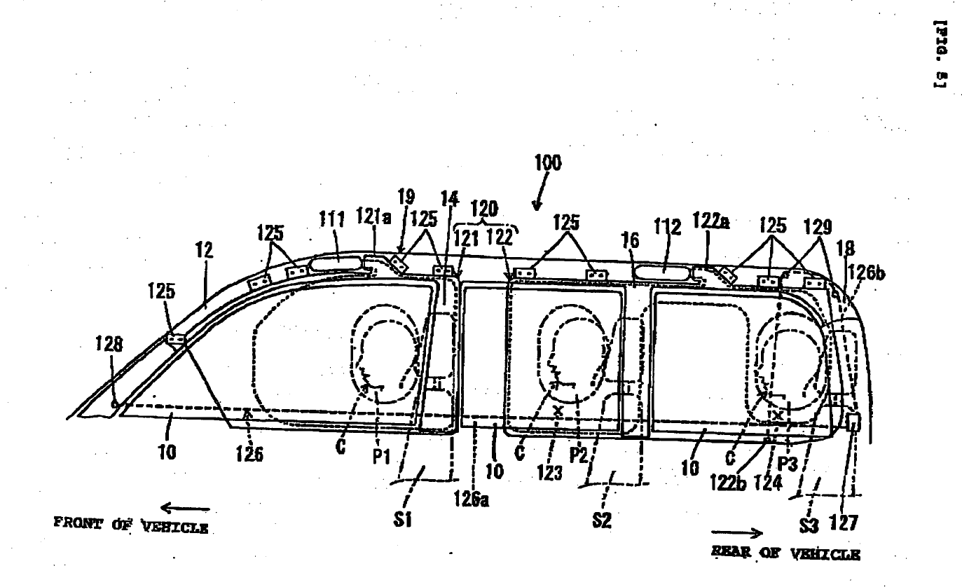

Referring also to FIGS. 4 and 5, the operation of this system 100 will be described. FIG. 4 is a diagram of the airbag 120 in FIG. 3 in a fully deployed state, as viewed from the front of a vehicle. FIG. 5 is a diagram of the airbag 120 in FIG. 3 in a fully deployed state, as viewed from the side of a vehicle. In FIG. 4, the state of the head of an occupant C before the occurrence of the side collision or rollover of a vehicle is indicated by a chain double-dashed line, while the state of the head of the occupant C at the side collision or rollover of a vehicle is indicated by a solid line. FIG. 4 shows the right sidewall of a vehicle, in which the right indicates the interior of the vehicle and the left indicates the exterior of the vehicle. In FIG. 5, the left indicates the front of the vehicle and the left indicates the rear of the vehicle.

In the event of the side collision or rollover of a vehicle, the airbag system 100 in the initial state is activated to generate inflating gas from the first inflator 111 and the second inflator 112. The inflating gas generated from the first inflator 111 flows into the inner space of the first airbag 121 through the inlet 121a, while the inflating gas generated from the second inflator 112 flows into the inner space of the second airbag 122 through the inlet 122a. The gas which has flowed in through the inlets 121a and 122a is guided regularly in the inner spaces of the first airbag 121 and the second airbag 122, respectively, to form desired gas flow. Thus the first airbag 121 and the second airbag 122 start a deploying and inflating action (inflating action while deploying) to push open the ceiling panel 15, as shown in FIG. 4, thus deploying downward toward the occupant protection regions P1, P2, and P3 formed between the right sidewall (side window 10) and the occupants C.

Thus, the first airbag 121 and the second airbag 122 enter the deployed and inflated state, as shown in FIGS. 4 and 5. Specifically, the first airbag 121 and the second airbag 122 deploy quickly and reliably into the spaces (occupant protection regions P1, P2, and P3 in FIG. 4) between the right sidewall (side window 10) and the heads of the occupants C, with the upper part supported by the right side-roof rail 19 via the multiple brackets 125. At that time, the first airbag 121 deploys in the occupant protection region P1 corresponding to the first-row seat S1 to protect at least the head of the occupant C who sits in the first-row seat S1. Of the inflating parts of the second airbag 122, the first inflating part 123 deploys in the occupant protection region P2 corresponding to the second-row seat S2 to protect at least the head of the occupant C who sits in the second-row seat S2. Of the inflating parts of the second airbag 122, the second inflating part 124 deploys in the occupant protection region P3 corresponding to the third-row seat S3 to protect at least the head of the occupant C who sits it the third-row seat S3.

In this way, the airbag 120 according to the embodiment is constructed such that two airbags (the first airbag 121 and the second airbag 122) deploy separately in the occupant protection regions P1, P2, and P3 formed from the first-row seat S1 to the third-row seat S3 upon completion of deployment.

As shown in FIGS. 4 and 5, the first extending part 126a of the tension rope 126 moves downward entirely as the first airbag 121 and the second airbag 122 deploy downward toward the occupant protection regions P1, P2, and P3, while the end of the second extending part 126b adjacent to the mounting portion 122b is drawn downward. Upon completion of the inflation of the first airbag 121 and the second airbag 122, the extending action of the first extending part 126a of the tension rope 126 is restricted by the fixing function (locking function) of the fixing device 127 and so extends with a specified tension applied between the fixing portion 128 and the device 127. Briefly, the tension rope 126 forms a tension line for the first airbag 121 and the second airbag 122. At that time, the first airbag 121 and the second airbag 122 are retained to the first extending part 126a of the tension rope 126 which is stretched at a specified tension. In other words, the first airbag 121 and the second airbag 122 are retained indirectly to the vehicle body via the tension rope 126. The tension applied to the first airbag 121 and the second airbag 122 via the tension rope 126 is set so that the first airbag 121 and the second airbag 122 extend in sheet form in the occupant protection regions P1, P2, and P3 on the side of the occupants in order to protect at least the heads of the occupants effectively from the input of side impact. The inflated first airbag 121 and second airbag 122 are therefore held in fully deployed positions and as such, the movements toward the exterior (in the direction of an arrow 30 in FIG. 4) and the upper part of the vehicle (in the direction of an arrow 32 in FIG. 4) are restricted.

This ensures that the first airbag 121 and the second airbag 122 which are deployed into the occupant protection regions P1, P2, and P3 extend in sheet form on the side of the occupants in the event of a vehicle accident such as side collision or rollover, thereby increasing the capability of holding the occupants in the cabin, thus allowing perfect protection of the occupants particularly in the event of side impact.

Since airbags which have deployed downward from above the vehicle sidewall have generally more flexibility at the lower part than at the upper part, restricting the action of the lower parts of the first airbag 121 and the second airbag 122 via the tension rope 126, as in the embodiment, is effective in surely restricting the action of the entire airbag 120.

In fixing (locking) the tension rope 126 with the fixing device 127, a specified tension is applied to the tension rope 126 before a load is applied from the occupants by fixing (locking) the tension rope 126 before the load is applied from the occupants via the airbag 120.

With the airbag system 100 according to the embodiment, the airbag 120 is constructed of the first airbag 121 and the second airbag 122. Accordingly, the deviation of time required to inflate the airbag can be decreased to allow a well-balanced inflating action even for vehicles having three-row seats or more in which the occupant protection region expands to increase the volume of the entire airbag.

With the airbag system 100 according to the embodiment, the capability of holding the occupants in a cabin can be increased in the event of an accident such as a side collision or turnover of the vehicle by restricting the movements of the fully deployed first airbag 121 and second airbag 122 toward the exterior of the cabin and the upper part of the vehicle. Since the embodiments are constructed such that the function of restricting the movement of the airbag is used for both of the first airbag 121 and the second airbag 122, a rational low-cost airbag system can be constructed as compared with that having a restricting mechanism for each airbag. Providing a simple restricting mechanism by the tension rope 126 and the fixing device 127 which fixes (locks) the tension rope 126 ensures reliable restricting of the movements of the inflating first airbag 121 and second airbag 122 toward the exterior of the cabin and the upper part of the vehicle.

The use of the airbag system 100 according to the embodiment simplifies the engagement of the tension rope 126 and the first and second airbags 121 and 122 by the structure in which the tension rope 126 is passed through the first and second airbags 121 and 122. Since the movements of the deployed multiple airbags toward the exterior and the upper part of the vehicle can be restricted with the tension rope 126 at a time, it is rational.

It is to be understood that the present invention is not limited to the above-described embodiment but various applications and modifications can be made. The following application examples of the embodiment are possible.

The foregoing embodiment takes the airbag system 100 that protects the occupant C seated on the right of the vehicle as an example for convenience of explanation. In addition to the airbag system 100, however, an airbag system having the same structure as the airbag system 100 is also mounted in practice to protect an occupant seated on the left of the vehicle. The airbag system has a structure in which a system having a bilaterally symmetrical structure to that of the airbag system 100 is fixed to a left side-roof rail.

The foregoing embodiment has been described for a case in which the first inflator 111 is used to supply gas to the first airbag 121, and the second inflator 112 is used to supply inflating gas to the second airbag 122. In one embodiment, however, may be constructed to use one inflator to supply inflating gas to both of the first airbag 121 and the second airbag 122.

The foregoing embodiment has been described for a case in which the airbag 120 is constructed of the two separate first airbag 121 and second airbag 122. An embodiment of the invention, however, may be constructed such that the airbag 120 is composed of three or more separate airbags. For example, the airbag 120 may be composed of three separate airbags, each of which deploys in an occupant protection region corresponding to the respective row of seat.

The foregoing embodiment has been described for a case in which the first airbag 121 corresponds to the first-row seat S1 and the second airbag 122 corresponds to the second-row seat S2 and the third-row seat S3. An embodiment of the invention, however, may have a structure in which the first airbag 121 corresponds to the first-row seat S1 and the second-row seat S2 and the second airbag 122 corresponds to the third-row seat S3.

The foregoing embodiment has been described for a case in which the tension rope 126 is passed through the through holes in the first airbag 121 and the second airbag 122. An embodiment of the invention, however, may have a structure in which the tension rope 126 is passed through a through hole provided in the lower part of the outer surface of each airbag or a structure in which the tension rope 126 is sewn onto the lower part of the outer surface of each airbag.

The foregoing embodiment has been described for a case in which the tension rope 126 and the fixing device 127 for fixing (locking) the tension rope 126 are used as a mechanism configured to restrict the movements of the deployed first airbag 121 and second airbag 122 toward the exterior and the upper part of the vehicle. Another embodiment of the invention, however, has only to have a structure in which the movements of multiple airbags toward at least the exterior of the vehicle with a single restricting mechanism, and various modifications of the restricting mechanism can be made as necessary. An embodiment may have a structure in which multiple airbags are joined together with a joining mechanism such as a link strap and one of the joined airbags is retained to the vehicle with retaining mechanism such as a tension strap or a guide rod. With such a structure, multiple airbags are retained directly to the vehicle with the retaining mechanism.

The foregoing embodiment has been described for the structure of an airbag system to be mounted in a car in which three-row of seats can be disposed. However, another embodiment of the invention can be applied to the structure of an airbag system to be mounted in various vehicles including trains and vessels in which multiple rows (two, three, four, five rows or more) of seats can be disposed, in addition to the small or large cars.

Embodiments of the present invention are made to achieve the above object. An embodiment of the invention can be applied to the structure of an airbag system to be mounted in various vehicles including small and large cars, trains, and vessels in which multiple rows of seats can be disposed. The vehicle may have multiple seats at all times or, alternatively, as the need arises.

The priority application, Japanese Patent Application No. 2004-032341, filed Feb. 9, 2004 including the specification, drawings, claims and abstract, is incorporated herein by reference in its entirety.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag system to be mounted in a vehicle capable of having a plurality of rows of seats, the airbag system comprising:
a plurality of airbags mounted to the upper part of the sidewall of the vehicle and, in the event of an accident, configured to deploy downward separately toward occupant protection regions between the occupants sitting in the seats and the sidewall of the vehicle;
gas supply device capable of supplying inflating gas into the plurality of airbags; and
single restricting mechanism configured to restrict the movement of the plurality of airbags deploying into the occupant protection regions toward the exterior of the vehicle cabin.

2. An airbag system according to claim 1, wherein the single restricting mechanism includes a rope member extending longitudinally along the length of the vehicle in the lower part of the plurality of airbags deploying into the occupant protection regions and in engagement with the lower part of the airbags and a fixing device for fixing the rope member.

3. An airbag system according to claim 2, wherein
the rope member is disposed in a state in which the plurality of airbags is passed along the length of the vehicle, with the airbags housed in the upper part of the sidewall of the vehicle.

4. An airbag system to be mounted in a vehicle capable of having three rows of seats, the airbag system comprising:
first and second airbags mounted to the upper part of the sidewall of the vehicle and, in the event of an accident, configured to deploy downward separately toward occupant protection regions between occupants sitting in the seats and the sidewall of the vehicle;
a gas supply device configured to supply inflating gas into the first and second airbags; and
wherein a single restricting mechanism extends longitudinally along the length of the vehicle in the lower part of the first and second airbags deploying into the occupant protection regions, and includes a rope member in engagement with the lower part of the first and second airbags and a fixing device for fixing the rope member, and wherein the single restricting mechanism is configured to restrict the movement of the first and second airbags deploying into the occupant protection regions toward the exterior of the vehicle cabin.

5. An airbag system according to claim 4, wherein the rope member is disposed in a state in which the first and second airbags are passed along the length of the vehicle, with the first and second airbags housed in the upper part of the sidewall of the vehicle
